(19) United States
(12) Patent Application Publication
(10) Pub. No.: US 2012/0176580 A1
(43) Pub. Date: Jul. 12, 2012

(54) ELECTRONICS ASSEMBLY IN LOW-VISION READER

(75) Inventor: Jeffrey Sonsino, Nashville, TN (US)

(73) Assignee: VANDERBILT UNIVERSITY, Nashville, TN (US)

(21) Appl. No.: 13/325,293

(22) Filed: Dec. 14, 2011

Related U.S. Application Data
(63) Continuation-in-part of application No. 13/090,125, filed on Apr. 19, 2011, now Pat. No. 8,109,630.
Application No. 13/090,125 is a continuation of application No. 11/532,566, filed on Sep. 18, 2006, now Pat. No. 7,942,522.
(60) Provisional application No. 60/725,144, filed on Oct. 11, 2005.

(51) Int. Cl. G02C 11/04; H05B 37/02

(52) U.S. Cl. 351/158; 315/160

(57) ABSTRACT

A low-version reader (LVR) includes a frame adapted to be worn by a person as well as first and second light sources supported by the frame and positioned to project light beams focusing on a working surface. The LVR also includes a first battery embedded in the frame and a first power-supply circuit that regulates power provided by the first battery to energize the first light source. The first battery is rechargeable and in electrical communication through a first discharge path with the first light source. The first discharge path allows the first battery to energize the first light source. A first charger receptacle in electrical communication through a first charge path with the first battery. The first charge path allows charging the first battery when a power charger is coupled with the first charger receptacle.

### CROSS-REFERENCE TO RELATED APPLICATIONS

This application is a continuation-in-part of U.S. patent application Ser. No. 13/090,125, filed on Apr. 19, 2011, which status is pending and is a continuation of U.S. patent application Ser. No. 11/532,566, now as U.S. Pat. No. 7,942,522, filed on Sep. 18, 2006, which claims the benefit of U.S. Provisional Application No. 60/721,544, filed Sep. 29, 2005. The disclosures of the above applications are incorporated herein by reference in their entireties, respectively.

### FIELD OF THE INVENTION

The present invention relates to a vision enhancement system for aiding in the correction of the vision of the visually impaired.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Many people in the world today suffer from some type of visual impairment. Vision impairment refers to that which cannot be adequately compensated for by using corrective lenses (glasses or contact lenses) or surgery.

Low vision is generally considered to be vision poor enough to keep someone from being able to read the newspaper while wearing their habitual glasses. Visual acuity that results in this type of impairment can range anywhere from 20/20 (with a very constricted visual field) to 20/400 or worse, depending on the cause of the vision impairment. Low vision results from a variety of diseases or conditions. Age-related macular degeneration accounts for about 65% to 75% of patients requesting vision rehabilitation. Diabetic retinopathy, glaucoma, hereditary retinal degenerations or diseases such as retinitis pigmentosa, albinism, Leber's optic neuropathy, and Best's disease account for many other causes of low vision.

In order to cope with this disability, individuals work closely with a Low Vision Rehabilitation Specialist (an optometrist or ophthalmologist who has a special interest in and who has been trained in Low Vision Rehabilitation) or other professionals who specialize in specific aspects of low vision rehabilitation, such as occupational therapists, orientation and mobility instructors, educators who specialize in teaching both children and adults with poor vision, social workers and researchers. Low Vision Rehabilitation is available in most major medical centers and, in some cases, in private practices.

A Low Vision evaluation begins with a comprehensive patient history. This includes a medical, drug, social, work, and vision history. A meticulous refraction is then done to determine the patient's best possible visual acuity. Additional tests are done to determine what is needed to enable the patient to read. This correction may range from a simple pair of reading glasses to a magnifier or a complex system such as a telemicroscope or CCTV (closed circuit TV).

Other areas of the patient's lifestyle are addressed such as work needs, hobbies, social needs, recreational needs, financial and personal needs. For example, complex systems can be designed for someone who works on a computer and who needs large print or voice-activated programs. Every effort is made to enable the individual to continue working at his/her present job, or, if necessary, retraining individuals in new areas of employment.

Low Vision Rehabilitation is an approach to making the best possible use of the healthy vision remaining in the eye. The Low Vision Specialist has at her/his disposal a vast array of devices designed to help the visually impaired see better. These can include magnifiers, microscopic lenses, telescopes, electronic devices such as closed-circuit TV's, even virtual imagery. Proper lighting used in the proper manner, bold lined writing utensils and paper, large print books and magazines, large print checks and many other useful devices help with coping with vision loss.

In addition, individuals may need to work with an occupational therapist to learn to use these devices effectively. A social worker can identify community-based programs that may be beneficial. Most people who have had expert Low Vision Rehabilitation can read, write, use their computer and generally function at a relatively high level.

However, Low Vision Rehabilitation in no way affects the physical condition of the eye. It cannot make the disease better and it cannot make it worse. The goal of Low Vision Rehabilitation is to learn to use the remaining healthy vision as effectively and efficiently as possible.

A number of devices exist in the prior art for helping individuals cope with Macular Degeneration and other visual impairments. For example, U.S. Pat. No. 5,151,722 to Massof et al, incorporated by reference herein, discloses a head-mounted display for providing a monocular or binocular wide field of view. This display contains folding optics and a CRT for projecting a viewed image onto the eye. This and similar systems known as LVES (Low Vision Enhancement Systems), have a number of significant disadvantages. These systems are large, heavy and cumbersome and cannot be worn comfortably by the patient.

Because of their weight and awkward configuration, LVES systems also have the significant disadvantage that it is difficult for the patient to read effectively while wearing the unit and it is extremely difficult to move from place to place. This is because even very small amounts of movement will create image flutter and a blurring of the image that is projected onto the patient's eyes. This undesired motion and blurring of images causes the eyes to fatigue quickly and greatly increases eye strain.

These systems also cannot be used with a patient's normal prescription glasses because of their size and configuration, and the optics contained therein. Nor can they be readily optimized for changes in a patient's condition or even for different patients. Each unit must be customized for a particular condition and for a particular patient.

U.S. Pat. Nos. 5,125,046; 5,267,331, and 5,359,675, all of which are incorporated by reference herein, also disclose an image enhancement system for the visually impaired. This system is usable as a table-mounted display system or as head-mounted video spectacles. However, this system, like the LVES system, suffers from a number of significant disadvantages. These systems are also limited in that they cannot be easily reconfigured for the changing needs of the patient, and do not allow for the patient to wear his or her own prescription glasses while wearing the head-mounted enhancement system. This is a significant disadvantage in that the rehabilitation specialist cannot easily work with the patient while wearing the device to test and help improve the patient's vision. These systems also cannot be readily optimized for the needs of a different patient, but are instead designed and built for a specific application.

Because of these significant disadvantages inherent in conventional vision enhancement systems, a visual rehabilitation system is needed which significantly reduces the susceptibility of the system to motion, is easily adaptable to the changing needs of the patient, which can be readily optimized for the needs of different patients, and which will be a tremendous aid in the rehabilitation of patients coping with low vision and other visual impairments.

Thus, it should be apparent that a need exists for improved reading glasses or spectacles for aiding patients with low-vision or macular degeneration wherein the glasses use a single lens for each eye. It is an object of the present invention to provide improved low-vision enhancement systems.

### SUMMARY OF THE INVENTION

Certain aspects of the present disclosure are directed to a low-version reader (LVR). The LVE includes a frame adapted to be worn by a person as well as first and second light sources supported by the frame and positioned to project light beams focusing on a working surface. The LVR also includes a first battery embedded in the frame and a first power-supply circuit that regulates power provided by the first battery to energize the first light source.

In accordance with certain aspects of the present disclosure, the first power-supply circuit regulates a current applied to the first light source.

In accordance with certain aspects of the present disclosure, the first and second light sources are positioned inwardly such that, when the LVR is assembled with a pair of lenses that generally define a first longitudinal axis and a first plane generally on which the pair of lenses are positioned, the light beams projected by the first and second light sources each have a center axis in a plane that has an angle less than 90 degree relative to the first plane and that is perpendicular to a second plane, the second plane being generally perpendicular to the first plane and the longitudinal axis being generally in, or parallel to, the second plane.

In accordance with certain aspects of the present disclosure, the first and second light sources are further positioned such that the center axis of each of the light beams is in a plane in, or parallel to, which the first longitudinal axis is generally and that generally has an angle less than 90 degree relative to the second plane.

Certain aspects of the present disclosure are directed to an electronics assembly. The electronics assembly includes a first light source as well as at least one first battery that is rechargeable and in electrical communication through a first discharge path with the first light source. The first discharge path allows the first battery to energize the first light source. The electronics assembly further includes a first charger receptacle in electrical communication through a first charge path with the first battery. The first charge path allows charging the first battery when a power charger is coupled with the first charger receptacle. The electronics assembly further includes a first power-supply module that regulates power provided by the first battery to energize the first light source.

In accordance with certain aspects of the present disclosure, the electronics assembly further includes a first control module that is configured to receive a first voltage from the first battery, in response to the first voltage that is above a first threshold, disallow charging the first battery, in response to the first voltage that is not below a second threshold and not above the first threshold, allow charging the first battery, and in response to the first voltage that is below the second threshold, disallow energizing the first light source by the first battery.

Certain aspects of the present disclosure are directed to an electrical circuitry. The electrical circuitry includes an LED having an anode and a cathode; a charger receptacle having an anode and a cathode; at least one battery that is rechargeable, an anode of the battery being in electrical communication with the anode of the charger receptacle and the anode of the LED; and a power-supply circuit that regulates power provided by the battery to energize the LED, the power-supply circuit having first, second, and third nodes. Further, the first node is in electrical communication with the anode of the LED, the second node is in electrical communication with the cathode of the LED, and the third node is in electrical communication with the cathode of the battery.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a low vision reader or spectacles in accordance with certain embodiments of the present disclosure;

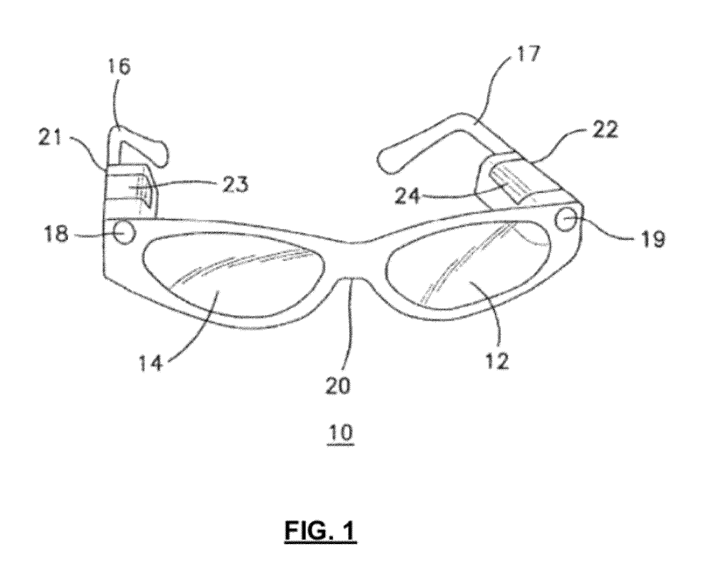

FIG. 2 a top view of another low-vision reader or spectacles in accordance with certain embodiments of the present disclosure;

FIGS. 3A-B illustrate light beams projected by light sources of the LVR in accordance with certain embodiments of the present disclosure;

FIG. 4 is a schematic figure of an electronic assembly of the low-vision reader or spectacles in accordance with certain embodiments of the present disclosure;

FIG. 5 is a schematic figure of another electronic assembly of the low-vision reader or spectacles in accordance with certain embodiments of the present disclosure; and

FIGS. 6A-B show a charger of the low-vision reader or spectacles in accordance with certain embodiments of the present disclosure.

### DETAILED DESCRIPTION OF THE INVENTION

The foregoing description is merely illustrative in nature and is in no way intended to limit the disclosure, its application, or uses. It should be understood that throughout the drawings, corresponding reference numerals indicate like or corresponding parts and features. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. A module can be, or be implemented by, one or more devices or physical components.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

Terms which are not defined (including terms used for science and technology, such as technical terms or academic parlance) can be used as terms which have meaning equal to general meaning that an ordinary person skilled in the art understands. It is preferable that terms defined by dictionaries or the like be construed as consistent meaning with the background of related art.

Terms such as “first,” “second,” “third,” and the like are used for distinguishing various elements, members, regions, layers, and areas from others. Therefore, the terms such as “first”, “second”, “third”, and the like do not limit the number of the elements, members, regions, layers, areas, or the like. Further, for example, the term “first” can be replaced with the term “second”, “third”, or the like.

Terms for describing spatial arrangement, such as “over”, “above”, “under”, “below”, “laterally”, “right”, “left”, “obliquely”, “behind”, “front”, “inside”, “outside”, and “in” are often used for briefly showing a relationship between an element and another element or between a feature and another feature with reference to a diagram. Note that embodiments of the present invention are not limited to this, and such terms for describing spatial arrangement can indicate not only the direction illustrated in a diagram but also another direction. For example, when it is explicitly described that “B is over A”, it does not necessarily mean that B is placed over A, and can include the case where B is placed under A because a device in a diagram can be inverted or rotated by 180°. Accordingly, “over” can refer to the direction described by “under” in addition to the direction described by “over”. Note that embodiments of the present invention are not limited to this, and “over” can refer to any of the other directions described by “laterally”, “right”, “left”, “obliquely”, “behind”, “front”, “inside”, “outside”, and “in” in addition to the directions described by “over” and “under” because the device in the diagram can be rotated in a variety of directions. That is, the terms for describing spatial arrangement can be construed adequately depending on the situation.

Terms such as “about,” “approximately,” “generally,” “substantially” unless otherwise indicated mean within 20 percent, preferably within 10 percent, further preferably within 5 percent, and even more preferably within 3 percent of a given value or range. Numerical quantities given herein are approximate, meaning that the term “about,” “approximately,” “generally,” or “substantially” can be inferred if not expressly stated.

It is discovered that low vision in patients suffering there from can be vastly improved by employing lighted reading glasses wherein the lenses contain induced prism and the glasses are equipped with devices that project light onto the field of vision. The lenses of the spectacles preferably have a dioptic power of from about +4.00 to about +20.00 and a prism preferably of from about 4 PD to about 22 PD. The eyeglasses are able to project sufficient light on the area of focus to aid in the reading of written or typed information therein.

The low-vision reader (LVR) or spectacles of the present disclosure can be far less bulky, transportable and easier to use than the reading aids heretofore employed for those with low vision.

The present disclosure is further illustrated by reference to the drawing which depicts the LVR or spectacles 10 according to the present disclosure, in which are located, mounted in frame 20, lenses 12 and 14, each having a predetermined dioptic power and prism. The LVR are further provided with temple arms 16 and 17 for affixing the spectacles over the ears of the user. The temple arms, 16 and 17 are preferably connected by a hinge to the frame 20 to allow folding of the glasses into a compact shape and size suitable for ease of carrying and transporting. Mounted on the LVR, preferably on the front of the frame 20 are light sources 18 and 19, preferably LEDs that project light onto an area of focus 22. It will be understood by those skilled in the art that any type of light sources capable of projecting light onto the area of focus sufficient to aid the user in reading may be employed in place of the depicted LEDs. A light source is preferably placed at each temple, i.e., the front of the frame 20 adjacent to the temple arms so as to focus at substantially the same distance that the lenses focus. The light sources are also preferably provided with power sources (not shown) such as batteries, preferably located in housings 21 and 22, which are preferably mounted on the interior sides of temple arms 16 and 17, adjacent to the area at the rear of frame 20 which, in turn, is adjacent to light projectors 18 and 19. Each power source is preferably actuated by a switch means 23 and 24, which may be incorporated into housings 21 and 22 so as to either automatically effectuate supply of electrical power to the light sources 18 and 19 when the glasses 10 are unfolded from their compact state for use by the intended user or so as to be manually operable by the intended user when desired or both. It will be understood that the present disclosure also embodies the use of one or more than two light sources in such applications where such arrangements are advantageous. The LVR is preferably designed to focus at a maximum distance of 25 cm and a minimum of 5 cm (i.e., between +4.00 and +20.00 diopters).

The predetermined lighted areas of focus are designed to preferably comprise cones of light increasing in size further from the LVR so that the overlapping lighted area has a conical shape leaving only peripheral areas in the field of view of the lenses that are lit by a single one of the lights with the peripheral areas becoming progressively smaller as distances from the lenses increase.

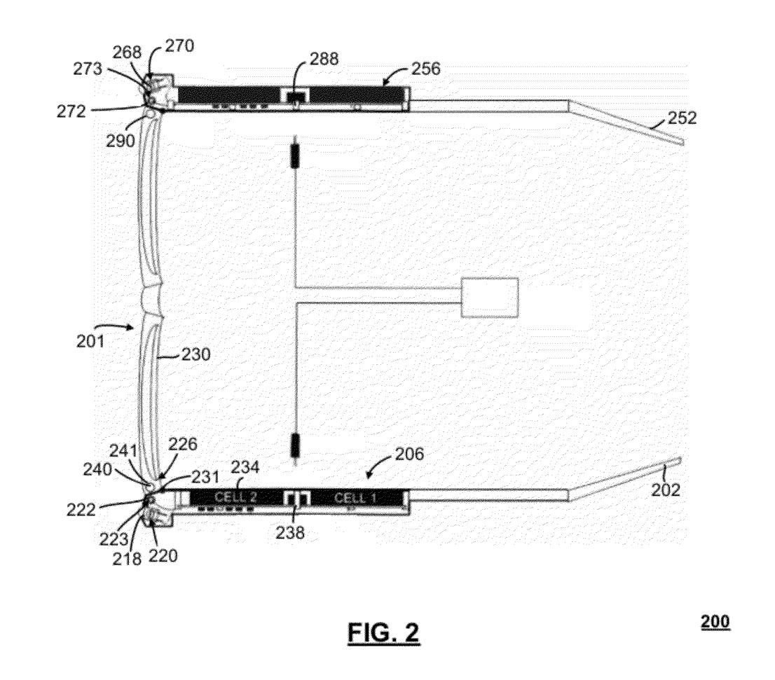

FIG. 2 shows another LVR 200 in certain embodiments of the present disclosure. The frame 201 of the LVR 200 has two temple arms 202, 252. Electronics circuits, components, modules, and/or boards can be placed in cavities, or embedded in the frame of the LVR 200. Although sometimes only descriptions with respect to the lower half of the LVR 200 as shown in FIG. 2 are provided below, one skilled in the art should appreciate that the configurations of the upper half of the LVR 200 are similar to those of the lower half unless otherwise specified. A battery 206, especially a rechargeable battery, can be placed in a cavity of the temple arm 202. In the specific example shown in FIG. 2, the battery 206 in the temple arm 202 includes a pair of cells 232, 234 that are placed next to each other in a longitudinal direction of the temple arm 202. The battery 206 can energize, or supply electricity, to the light source 218 through an electrical communication path. A switch 222 is placed in the electrical communication path. The switch 222 can be turned on to connect the electrical communication path, allowing the battery 206 to energize the light source 218. The switch 222 can be turned off to disconnect the electrical communication path, thus disallowing the battery 206 to energize the light source 218.

The frame 201 has a connecting bracket 226 that is fixed to a lens 230 of the LVR 200. The temple arm 202 is, at its front end, connected to the connecting bracket 226 through a hinge 231. The temple arm 202 can rotate about the hinge 231 from the first position to a second position relative to the connecting bracket 226. In certain embodiments, at the first position the temple arm 202 is generally perpendicular to a plane defined by the lens 230; at the second position, the temple arm 202 is generally parallel to the plane defined by the lens 230. The temple arm 202 can be open or folded relative to the lens 230.

In certain embodiments, a light source 218, 268 is placed at a cavity 220, 270 at the front end of each of the temple arms 202, 252. In certain embodiments, the light sources 218, 268 are High Brightness White Light Emitting Diodes (LEDs). The LEDs 218, 268 are mounted on the frame 201 of the LVR 200 and directly illuminate the viewing area 310 with sufficient intensity that results in significant contrast enhancement for the user. The LEDs 218, 268 are selected for their high efficiency, providing the high brightness to current ratio. The placement and positioning of the two LEDs 218, 268 provide concentric additive illumination on the reading/work surface 310 resulting in greater comfort for the user.

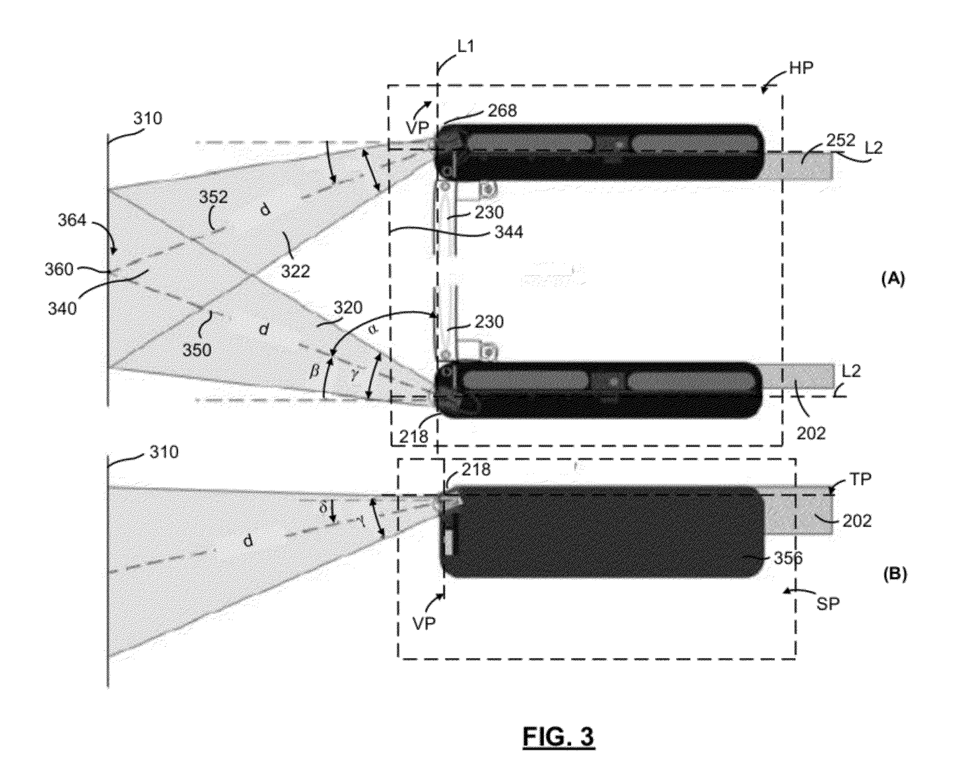

In certain embodiments, the light sources 218, 268 project light beams that are directed and focused onto a reading/work surface 310. For example, as shown in FIG. 3, the light beams 320, 322 projected by the light sources 218, 268 can generally have a conical shape. The light sources 218, 268 can be rotated or canted inwardly such that the light beams 218, 268 intersect and form an intersection space 340. There is also an area 344 in front of the LVR 200 that generally does not receive, or that receive less, light from the light sources 218, 268. The conical light beams 320, 322 define respective center axes 350, 352. The frame 201 of the LVR 200 is adapted to be assembled with a pair of lenses 230. When assembled, the pair of lenses 230 defines a first longitudinal axis L1 and a first plane VP, called vertical plane VP, where the two lenses 230 are generally positioned on the first plane VP and the longitudinal axis L1 is generally in or parallel to the vertical plane VP. The two lenses can also define a second plane HP, called horizontal plane HP, where the horizontal plane HP is perpendicular to the vertical plane VP and the first longitudinal axis L1 is in or parallel to the horizontal plane HP. In certain embodiments, the positions of the light sources 218, 268 are further canted or rotated inwardly such that, when assembled, each of the center axes 350, 352 is generally in a respective plane that is perpendicular to the horizontal plane HP and that forms an angle a less than 90°, for example of 67°, relative to the vertical plane VP. In certain embodiments, the two light sources 218, 268 are further tilted downwardly such that each of the center axes 350, 352 is generally in a respective plane that is generally parallel to the first longitudinal axis L1 and that forms an angle δ, for example of 10°, relative to the horizontal plane HP.

In addition or alternatively, in certain embodiments, each of the temple arms 202, 252 can define a second longitudinal axis L2 and a side plane SP that is generally parallel to a side face 356 of the temple arm 202. A top plane TP is defined as a plane that is parallel to the second longitudinal axis L2 and that is perpendicular to the side plane SP. In certain embodiments, the light sources 218, 268 are positioned such that the center axis 350, 352 of each of the light beams 320, 322 is generally in a plane that is perpendicular to the top plane TP and that forms an angle β less than 90°, for example of 23°, relative to the side plane SP. In certain embodiments, the light sources 218, 268 can be positioned such that the center axis 350, 352 of each of the light beams 320, 322 is in a plane that is perpendicular to the side plane SP and that forms an angle δ less than 90°, for example of 10°, relative to the top plane TP.

In certain embodiments, the axes 350, 352 of the light beams 320, 322 generally or substantially intersect at a intersection point 360 on the reading/work surface 310. The axes of the light beams may have a tolerable distance between each other on the reading/work surface 310. The tolerable distance can be, for example, one of 0.1, 0.2, 0.5, 0.8, 1, 2, and 5 cm. In certain embodiments, the intersection point 360 has the same distanced, for example 18 cm, from both of the light sources 218, 268. The areas 364 on the reading/work surface 310 covered by the light beams 218 268 generally, or substantially, overlap. In certain embodiments, the distance between the intersection point 360 and one of the light sources 218, 268 may differ from the distance between the intersection point 360 and the other light source 218, 268. The area 364 on the reading/work surface 310 covered by a one of the light beams 320, 322 may be offset from the area 364 covered by the other light beam 320, 322. In certain embodiments, the cone or truncated cone defined by the one or both of light beams 320, 322 has an aperture or open angle γ of, for example, 30°. In certain embodiments, both of the light beams have the apertures of the same degree. In certain embodiments, the light beams have apertures of different degrees. In certain embodiments, the light beams are calibrated to converge at a distance consistent with a lens power that is greater than about +4.00 diopters and less than about +20.00 diopters such that in use, the oculus lens focuses at a distance that is greater than about 5 cm and less than about 25 cm.

The needed LED parameters for the LVR 200 can have conflicting optical, electrical and mechanical characteristics which are compounded by commercial factors. The LED selection process is an on-going effort given the rapid technological developments and changing product availability issues. The electronics assembly of the present disclosure as will be described below can accommodate a wide range of LEDs.

In certain embodiments, the LEDs 218, 268 are attached to PC boards having batteries 206, 256 with flexible wires for conformance into the pre-formed directional cavities 220, 270 in the temple arms 202, 252.

In certain embodiments, 20 mA LEDs 218, 268 are used for the LVR 200. Although the LEDs 218, 268 are proximate to the user's eyes when the LVR is in use, the user typically can tolerate thermal dissipation of the LEDs 218, 268. Batteries 206, 256 embedded in the temple arms 202, 252 can supply sufficient current to the LEDs 218, 268. Typically, a 20 mA LED dissipates only ˜70 mW, which does not raise its temperature beyond the ambient. A battery 206, 256 with 165 mAh draining at the rate of 20 mA (0.12 C) lights-up the LED 218, 268 for 8.25 Hrs.

Typically, a 20 mA LED 218, 268 allows for luminous intensities in the range of 10,000 to 30,000 mcd with 30° light beams. With the geometry involved in the LVR application, this translates into illumination at the viewing surface 310 in the range of 400-700 1× per LED which provides a significant increase in the contrast for the user.

Typically, the useful life of the LED 218, 268 used at its rated 20 mA current is more than 10 years. In certain embodiments, given the fact that the batteries 206, 256 in the LVR have a life of about 500 charge/discharge cycles, the LED current can be increased to 25 mA, which is still lower than the typical max of 30 mA, at the expense of shortening its life. The light output of the LED 218, 268 typically increases in direct proportion to its current; therefore, at 25 mA, the 20 mA LED 218, 268 can produce 25% more light. In spite of the life penalty for such an increase, the LED 218, 268 still provides a useful life beyond the batteries' life.

In certain embodiments, the battery 206 has two rechargeable Lithium-Polymer battery cells 232, 234, which make the LVR 200 light enough to wear. The battery 206 provides sufficient energy storage such that the LVR 200 can be used long enough in between charges. The forward voltage drop of the LED 218 is typically 3.5V and a driver circuit drops another 1V. In order to be able to turn the LED 218 on, two cells 232, 234 in series forming a battery 206 of approx. 8.4V are used. When fully charged, each cell 232, 234 provides approx. 4V. When close to depletion, the voltage drops to approx. 3.5V. The two rechargeable cells 232, 234 are connected in series with a nominal charge capacity of 165 mAh (=1 C) and weight about 7.5 g total. 1 C is the numerical value of the charge capacity in mA.

In certain embodiments, for good battery management, the battery current should not exceed 1 C when charging and 0.5 C when discharging. In the LVR 200, the charger is limited to about 0.75 C when charging and the LED 218 only requires 0.15 C when discharging. The discharge period of a fully charged battery 206, 256 in each temple arm 202, 252 is about 6.5 hrs.

In certain embodiments, the benign use of the batteries 206, 256 with these constraints allows for approximately 500 charge/discharge cycles, after which the batteries' life is considered exhausted and the LVR 200 are no longer usable in a portable manner, but can still be operated with the charger plugged into the AC supply.

In certain embodiments, the temple arms 202, 252 have a charger receptacle 238, 288 that provides an entry points for an external charger to charge the batteries 206, 256.

In certain embodiments, a reed switch 222 is placed in a cavity 223 adjacent to the light source 218 at the front end of the temple arm 202. A permanent magnet 240 is placed in a cavity 241 in the connecting bracket 226. The reed switch 222 and the permanent magnet 240 are positioned such that when the temple arm 202 is at the first position, or open, relative to the connection bracket 226, the reed switch 222 and the permanent magnet 240 are close enough such that the permanent magnet 240 can turn on, or activate, the reed switch 222. When the temple arm 202 is at the second position, or folded, relative to the connecting bracket 226, the reed switch 222 and the permanent magnet 240 are remote enough such that the permanent magnet 240 cannot turn on, or activate, the reed switch 222.

The reed switches 222, 272 provide a reliable mechanism for the light sources 218, 268 to automatically turn-on when a user opens the temple arms 202, 252 in preparation for wearing the LVR 200. Due to the sealed environment for its contacts, the reed switches 222, 272 can be immune from oxidation with time unlike the mechanical switch counterparts. The small sizes of the reed switches make them very suitable to adapt to the LVR 200 with streamlined designs. In certain embodiments, the selected reed switches 222, 272 each measure 7 mm in length and 1.8 mmø. They are rated to switch up to 100 mA @ 24V, but can be used conservatively for 25 mA @ 8V. The selected magnets 240, 290 each are cylindrical in shape with dimensions of 1.5 mm Ø×3 mm (length) and coercive force of ˜10 kOe.

In certain embodiments, for proper operation of the reed switch 222 and the magnet 240 pair, their longitudinal axe needs to be aligned close to parallel with their medians coincident. Polarity of the magnet is not relevant. By appropriately selecting the magnet strength and pivot geometry of the temple arm 202, the reed switch 222 closes within about 3 mm of its magnet and opens when retracted by about 5 mm or more.

In certain embodiments, the LVR 200, once fully charged, can be operated by simply opening the temple arms 202, 252. The LEDs 218, 268 light-up when the reed switch 222, 272 mounted next to them come in close proximity of the small magnets 240, 290 embedded into the frame 201 beside the lenses.

In certain embodiments, the LEDs 218 268 always light-up at full intensity for the entire discharge period which, for example, can be approximately 6.5 hours with fully charged batteries 206, 256. At the end of this period, one LED 218, 268 may turn-off few minutes before the other 218, 268 due to a small difference in the amount of charge stored in the two batteries 206, 256. With only one LED 218, 268 lit, the light intensity drops about in half and is a good indication for the user to recharge the batteries 206, 256.

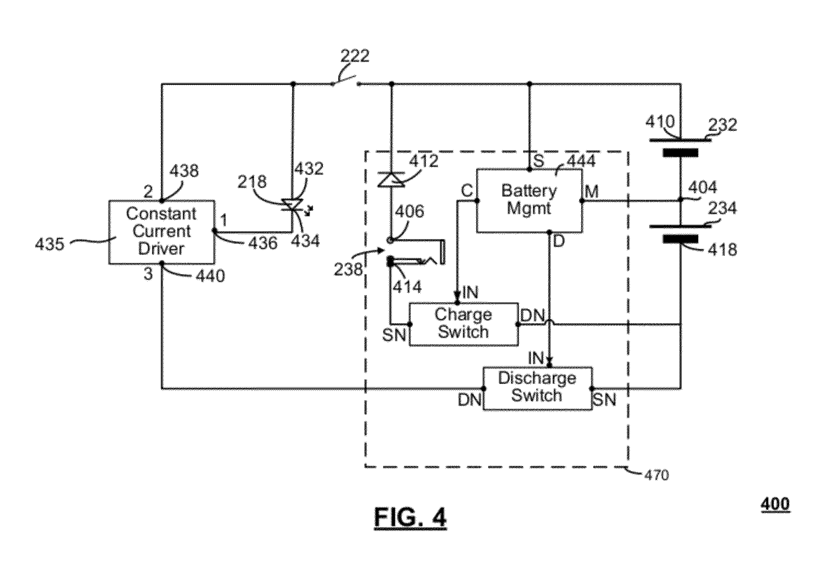

FIG. 4 is a schematic figure illustrating simplified electronic circuits of an electronics assembly 400 of the LVR 200 in certain embodiments, where a control module or control circuit 470 that can include a battery management module 444, a charge switch module 474, and a discharge switch module 478 is utilized to manage the batteries 232, 234 such as protecting the battery cells 232, 234 from overcharging, over-discharging. Certain components of the circuits may be omitted in the drawings for brevity and clarity. In certain embodiments, the battery management module 444 can be configured to alternatively or additionally protect the battery cells 232, 234 from over-discharging.

In the specific example shown in FIG. 4, the battery cell 232 and the second battery cell 234 are connected in series through an intermediate node 404. The anode 406 of the charger receptacle 238 is in electrical communications with the anode 410 of the first battery cell 232 through a diode 412. The cathode 414 of the charger receptacle 238 is in electrical communication with the cathode 418 of the second battery cell 234 through a charge switch module 474. The anode 410 of the first battery cell 232 is in electrical communication, through the reed switch 222, with the anode 432 of the LED 218 and with a second node 438 of a constant current driver 435. The cathode 434 of the LED 218 is in electrical communication with a first node 436 of the constant current driver 435. A third node 440 of the constant current driver 435 is in electrical communication with, through a discharge switch module 478, the cathode 418 of the second battery cell 234.

A battery management module 444 has integrated circuits and four nodes S, D, C, and M. Each of the charge switch module 474 and the discharge switch module 478 has a input node IN, a source node SN, and a drain node DN. The anode 406 of the charger receptacle 238 is in electrical communication with the S node through the diode 412. The M node is in electrical communication with the intermediate node 404. The D node is in electrical communication with the input node IN of the discharge switch module 478. The C node is in electrical communication with the input node IN of the charge switch module 474. The source node SN of the discharge switch module 478 is in electrical communication with the cathode 418 of the second battery cell 234. The source node SN of the charge switch module 474 is in electrical communication with the cathode 414 of the charger receptacle 238. The charge switch module 474 can selectively connect or disconnect a charge path, e.g. an electrical communication path that allows charging the batteries by a charger plugged into the charger receptacle 238. The discharge switch module 478 can selectively connect or disconnect a discharge path, e.g. an electrical communication path that allows energizing the LED 218 by the batteries 232, 234.

In certain embodiments, when using rechargeable batteries 232, 234 such as Lithium-Polymer battery cells, it is highly critical to maintain tight control of the charge/discharge modes and levels for personal safety and cell life reasons.

The above discussed features can improve safe use of the LVR 200 and the life for the battery cells 232, 234. As will be described below, fixed thresholds are selected for optimum operational range of the battery cells 232, 234 used in the LVR 200. The battery management module 444 monitors the voltages of the two serially connected battery cells 232, 234 and/or the discharge current to control charging and discharging. When the voltages of two battery cells 232, 234 (e.g., sensed by the S node) are less than an overcharge detection voltage, i.e., a first threshold, and more than an over-discharge detection voltage, i.e., a second threshold, and optionally the current flowing through the battery cells 32, 234 becomes equal or lower than a specified over-current value, the battery management module 444 can determine that the battery cells operate normally. The battery management module 444 can further output signals to the charge switch module 474 and the discharge switch module 478 to connect the charge and/or discharge paths. Accordingly, the charge switch module 474 and the discharge switch module 478 can connect the charge path and the discharge path, respectively, thus allowing continued charging and/or discharging operations. For example, the C and D nodes can output high signals such as about 8V to the input nodes IN of the charge switch module 474 and the discharge switch module 478. In this status, charging and discharging of the battery cells 32, 234 can be carried out freely. This is a normal status of the battery management module 444.

Optionally, when the discharging current determined by the battery management module 444 becomes equal to or higher than the specified over-current value during discharging under the normal status, the battery management module 444 can output signals to the discharge switch module 478 to disconnect the discharge path. For example, the D node can output a low signal such as 0V. Accordingly, that discharge switch module 478 can disconnect the discharge path. This is over-current status. In addition, the charge switch module 474 can accordingly disconnect the charge path.

In certain embodiments, the battery management module 444 detects overcharging if any of the battery cell voltages becomes higher than the overcharge detection voltage during charging under the normal status. The charge switch module 474 disconnects the charge path to stop charging. This is overcharge status.

The overcharge status is released when the battery voltage which exceeded the overcharge detection voltage falls below the overcharge release voltage. The charge switch module 474 connects the charge path and the battery management module 444 returns to the normal status.

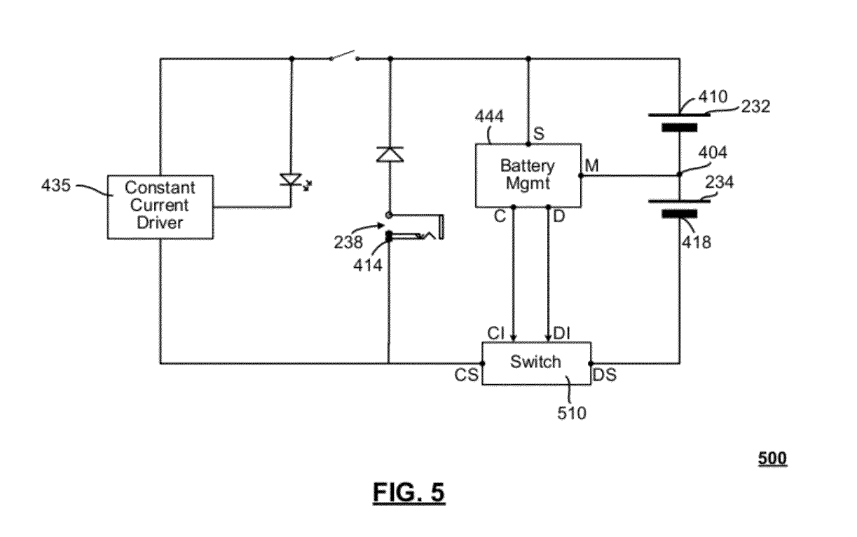

In certain embodiments, the above-mentioned charge and discharge switch modules 474, 478 can be implemented by transistors such as FETs and particularly MOSFETs. In certain embodiments, the above-mentioned charge and discharge switch modules 474, 478 can be the same switch module or implemented as one logical or physical switch module. The switch module, for example, can include two MOSFETs. FIG. 5 semantically shows simplified electronic circuits of an electronic assembly 500 that employs a switch module or a switch circuit 510. The electronic assembly 500 shown in FIG. 5 differs from the electronic assembly 400 shown in FIG. 4 in certain aspects and is similar in certain other aspects. The switch module (or circuit 510) is in the charge path and the discharge path, and has charge input node CI, discharge input node DI, charge source node CS, and discharge source node DS. The charge input node CI of the switch module 510 is in electrical communication with the node C. The charge source node of the switch module 510 is in electrical communication with the cathode 414 of the charger receptacle 238. The discharge input node of the switch module is in electrical communication with the node D. The discharge source node DS of the switch module 510 is in electrical communication with the cathode 418 of the second battery 234, and the switch module 510 selectively connect and disconnect the charge and discharge paths in accordance with signals received at the charge and discharge input nodes CI, DI. For example, the switch node can connect or disconnect the charge and discharge paths in response to high and low signals applied to the charge and discharge input nodes CI, DI, respectively.

Referring to FIG. 4, the charging phase, if the battery voltage sensed at the S node of the battery management module 444 exceeds the overcharge detection voltage, the C node of the battery management module 444 in electrical communication with the input IN of the charge switch module 474 can drop to about 0V and the charge path is disconnected, preventing an over-charge. In this state, the D node of the battery management module 444 in electrical communication with the input node IN of the discharge switch module 478 is at about 8V and the discharge path is connected, allowing the battery 232, 234 to discharge when the reed switch 222 is closed.

Similarly, during the discharge phase, if the battery voltage sensed at the S node of the battery management module 444 drops below the over discharge detection voltage, the D node of the battery management module 444 in electrical communication with the input node IN of discharge switch module 478 can drop to about 0V and the discharge path is disconnected, preventing an over-discharge. As soon as the charger is plugged in, in response to the higher voltage sensed at the S node of the battery management module 444, the C node can output a high signal to the input node IN of the charger switch module 474 which connects the charge path, starting to charge the batteries 232, 234.

In addition, in certain embodiments, the battery management module 444 can monitor the middle voltage at the intermediate node 404 through the M node and, when necessary, balances the levels of each cell 232, 234 individually. Without this feature, during multiple charge/discharge cycles, the stronger (higher voltage) cell can prevent the weaker one from fully charging, resulting in a shorter life of the battery. Further, the battery management module 444 can also provide protection for the batteries 232, 234 and the charger, when the charger is left powered beyond the completion of the charging cycle.

In certain embodiments, the electronics assembly 400, 500 further has a power supply circuit or power supply module that regulates power supplied by the batteries 232, 234 to the light sources 218, 268. The power-supply circuit can regulate a current applied to the light sources 218, 268. Additionally or alternatively, the power-supply circuit is in electrical communication with the batteries 232, 234 and a light source 218 and is configured to regulate the current provided to the light source 218 to be within a predetermined range. Additionally or alternatively, the power-supply circuit can regulate a voltage applied to the light source. In certain embodiments, the power supply circuit can be coupled with the light sources and operates in a way such that generally constant current and/or voltage is applied to the light sources. In the specific example shown in FIG. 4, the power supply circuit is the constant-current driver 435 that provides the light sources such as LEDs 218 to maintain constant intensity during the entire discharge period. For example, the selected LED current can be 25 mA and can be fixed by the design of the driver 435. During the discharge period as the battery voltage drops, this driver 435 helps to keep the LED current at the specified value, thus maintaining the light intensity for the user. For example, the constant current driver 435 can be a fixed, linear current regulator and are suitable for applications employing single or multiple LEDs. The constant current driver 435 can also be a voltage regulator.

In certain embodiments, a directional module is employed to prevent the internal circuits from being interfered from outside of the electronics assembly. In this specific example shown in FIG. 4, the power diode 412 is used. Each temple arm 202, 252 can be provided a electronics assembly. Without the power diode 412, when the charger outputs are plugged to the charger receptacles for charging the batteries 206, 256 in the two temple arms 202, 252 simultaneously, the charger outputs provide a direct path for the two batteries in each electronics assembly 400 to be interconnected in parallel thereby allowing current to flow from one side onto the other causing the assemblies 400 to malfunction. By restricting the charge current to flow only inwards, damage to the electronics assemblies 400 can be prevented in case of an accidental insertion of an incompatible charger with the center pin as the negative terminal. Due to the presence of the diode 412, shorting the input terminals has no or less effect on the electronics. In addition, as another safety measure, no battery power can be drained out via the charger receptacles. The first capacitor 424 provides some filtering for spikes in the charger current coupling via an AC outlet.

Referring back to FIG. 2, in certain embodiments, the electronics assembly 400 is packaged specifically to fit the temple arms 202, 252 of the LVR 200. The package dimensions can be dominated by the size of the battery cells 232, 234. In certain embodiments, surface mounted technology (SMD) is used for the electronics in order to minimize addition to the thickness of the assembly 400.

In certain embodiments, all active electronic components are mounted on one side 510 of a PC board 502 (the circuit side), while the battery cells 232, 234 are mounted onto the opposite side (the battery side) 520. The highest component which is the charger receptacle 238 is located in-between the two cells 232, 234 and does not contribute to additional overall thickness.

In certain embodiments, the terminal pads 514 for the reed switch 222 and the LED 218 are placed at the edge of the PC board 502 and these components are attached with flexible wires 522. This arrangement allows them to conform to the right and left temple arms 202, 252, thus allowing for a single design electronics assembly 400 to be used in two places.

In certain embodiments, the mechanical layout of the LVR 200 tightly couple with the electronics. The temple arms 202, 252 provide cavities 220, 223 for the LEDs 218 and the reed switches 222 for precise alignment. The concentric LED beams 320, 322 are created by the precise angling of the LEDs 218, 268 when seated into their respective cavities 220, 270. Similarly the reed switches 222, 272 are placed into cavities 223, 273 that precisely align them with their respective magnets 240, 290 embedded into the sides of the frame 201.

The mechanical restraints inside the temple arms 202, 252 lock the electronics assemblies 400 in place and line them up with the charger access holes. The temple arms 202, 252 are sealed after installation and testing of the electronics assemblies.

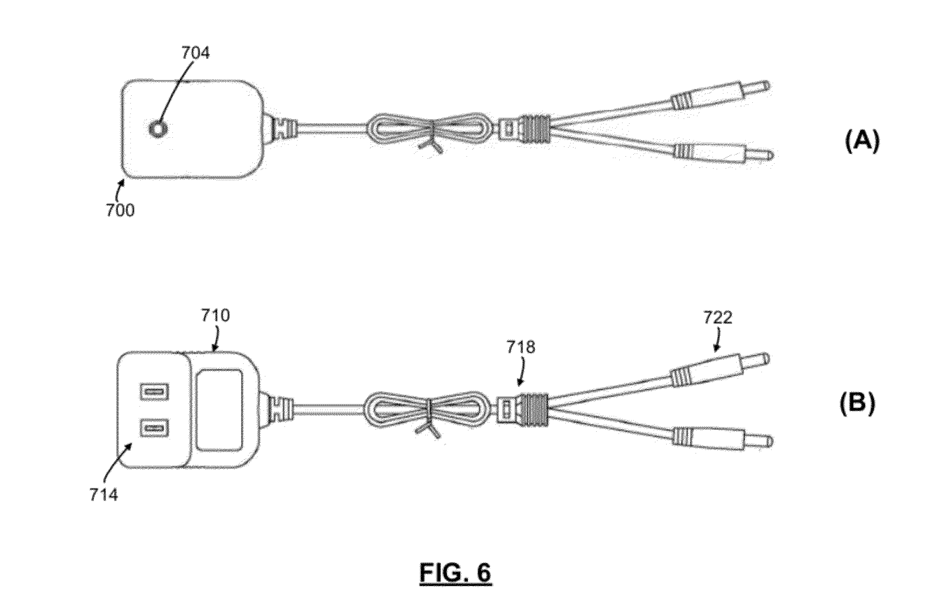

FIGS. 6A-6B show a charger 700 in accordance with certain embodiments of the present disclosure. The charger 700 is designed to operate in conjunction with the parameters of the batteries 206, 256 and can charge the batteries 206, 256 in each temple arm 202, 252 simultaneously. A status indicator 704 which can change color (e.g. Red/Green) notifies the user of the completion of the charge cycle. The charger 700 is capable of charging the batteries 206, 256 simultaneously for expediency. However, it is possible to charge the battery 206, 256 of only one temple arm 202, 252 at a time. Furthermore, the batteries 206, 256 can also be charged while the LEDs 218, 268 are turned ON.

In certain embodiments, consistent with the requirements of the Lithium-Dolymer cells 206, 256, the charge phase starts with a low-rate pre-charge when the battery voltage is less than 6V, then switches to a constant current mode of about 0.5 C and then switches to a constant voltage mode when 8.4V is reached. During all this time the light indicator 704 on the charger 700 is RED. Finally, charging terminates when the current is below about 10 mA, at which time the light turns GREEN.

In certain embodiments, the process to charge the battery 206, 256 can be completed in less than 2.5 hours for a single temple arm 202, 252 and slightly longer with two temple arms. The charger 700 can supply sufficient current to both temple arms 202, 252 simultaneously charging the batteries 206, 256 with or without the respective LEDs 218, 268 turned-on. With the LEDs 218, 268 turned-on, the charge time will take slightly longer than without the LEDs 218, 268 lit.

In certain embodiments, the charger housing 710 has two prongs 714 for the AC supply which may range between 115-240 VAC±10% at 50/60 Hz without manual switching. The prongs 714 are directly compatible with the 115 VAC, 60 Hz US standard outlets but may require an appropriate adapter for the 240 VAC, 50 Hz foreign outlets.

In certain embodiments, safety for the user is ensured since the exposed wiring 718 to the charger is the low voltage 9V output. The “Y” arrangement of the output plugs 722 allow for charging the batteries 206, 256 in each temple arms 202, 252 simultaneously. The center pin in each plug 722 is the positive and the outside the negative terminals. There is no electrical path to common ground from these plugs. The charger outputs are protected for short circuits and feature automatic recovery.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A low-version reader, comprising:
a frame adapted to be worn by a person;
first and second light sources supported by the frame and positioned to project light beams focusing on a working surface;
a first battery embedded in the frame; and
a first power-supply circuit that regulates power provided by the first battery to energize the first light source.

2. The low-version reader of claim 1, wherein the first power-supply circuit regulates a current applied to the first light source.

3. The low-version reader of claim 1, wherein the first power-supply circuit regulates a voltage applied to the first light source.

4. The low-version reader of claim 1, wherein the first power-supply circuit is a constant current driver coupled with the first light source and configured such that generally constant current is applied to the first light source.

5. The low-version reader of claim 1, further comprising a first switch that selectively allows and disallows energizing the first light source by the first battery.

6. The low-version reader of claim 1, wherein the first and second light sources are positioned inwardly such that, when the LVR is assembled with a pair of lenses that generally define a first longitudinal axis and a first plane generally on which the pair of lenses are positioned, the light beams projected by the first and second light sources each have a center axis in a plane that has an angle less than 90 degree relative to the first plane and that is perpendicular to a second plane, the second plane being generally perpendicular to the first plane and the longitudinal axis being generally in, or parallel to, the second plane.

7. The low-version reader of claim 6, wherein the first and second light sources are further positioned such that the center axis of each of the light beams is in a plane (a) in, or parallel to, which the first longitudinal axis is generally and (b) that generally has an angle less than 90 degree relative to the second plane.

8. The low-version reader of claim 7, wherein the center axes of the light beams intersect at a point on the working surface.

9. The low-version reader of claim 1, wherein the frame includes a first temple arm that supports the first light source, the first temple arm defines a second longitudinal axis and a side plane that is generally parallel to a side face of the first temple arm;
wherein the first light source is positioned such that the center axis of the light beam projected by the first light source is generally in a plane that is perpendicular to a top plane and that has an angle less than 90° relative to the side plane, the top plane being generally parallel to the second longitudinal axis and perpendicular to the side plane.

10. The low-version reader of claim 9, wherein the first light source is positioned such that the center axis of the light beam projected by the first light source is in a plane that is perpendicular to the side plane and that has an angle less than 90° relative to the top plane.

11. The low-version reader of claim 1, wherein the frame includes:
a first temple arm; and
a first connecting bracket adapted to be fixed with a first lens, wherein the first connecting bracket is connected with the first temple arm through a first hinge;
wherein the first switch selectively allows and disallows electrical communication between the first light source and the first battery in accordance with positions of the first temple arm relative to the first connecting bracket.

12. The low-version reader of claim 11, further comprising:
a first magnet;
wherein the first switch is a first reed switch, the first temple arm rotates about the first hinge between first and second positions;
wherein the first reed switch and the first magnet each are located in a respective different one of the first connecting bracket and the first temple arm such that the first magnet turns on the first reed switch when the first temple arm is at the first position, and does not turn on the first reed switch when the first temple arm is at the second position.

13. The low-version reader of claim 12, further comprising:
a second temple arm; and
a second connecting bracket adapted to be fixed with a second lens, wherein the second connecting bracket is connected with the second temple arm through a second hinge;
a second magnet;
a second reed switch;
wherein the second temple arm rotates about the second hinge between third and fourth positions relative to the second connecting bracket;
wherein the second reed switch and the second magnet each are located in a respective different one of the second connecting bracket and the second temple arm such that the second magnet turns on the second reed switch when the second temple arm is at the third position, and does not turn on the second reed switch when the second temple arm is at the fourth position.

14. The low-version reader of claim 1, further comprising:
a first integrated circuit board embedded in the first frame, a battery management circuit mounted on the first integrated circuit board and configured to sense a voltage of the first battery and to, in response to a sensed voltage that is above a first threshold, disallow charging the first battery, as well as to, in response to a sensed voltage that is below a second threshold, disallow discharging the battery.

15. The low-version reader of claim 1, further comprising a first integrated circuit board, wherein the first integrated circuit board defines a plane that is substantially parallel to a major side face of the first temple arm;
wherein the first battery further comprises first and second cells that are adjacent to each other in a longitudinal direction of the first temple arm and that are mounted on the first integrated circuit board.

16. The low-version reader of claim 1, further comprising a first charger receptacle in electrical communication through a charge path with the first battery, wherein the first battery is a rechargeable battery and the charge path allows charging the first battery when a power charger is coupled with the first charger receptacle.

17. The low-version reader of claim 16, further comprising a charger having a first charger plug adapted to be coupled with the first charger receptacle.

18. The low-version reader of claim 1, further comprising an oculus lens that has an induced prism in a range between about 4 PD and about 22 PD with a lens power that is greater than about +4.00 diopters and less than about +20.00 diopters such that in use, the oculus lens focuses at a distance that is greater than about 5 cm and less than about 25 cm.

19. The low-version reader of claim 18, wherein the oculus lens is an oculus dexter lens or an oculus sinister lens.

20. An electronics assembly, comprising:
a first light source;
at least one first battery that is rechargeable and in electrical communication through a first discharge path with the first light source, wherein the first discharge path allows the first battery to energize the first light source;
a first charger receptacle in electrical communication through a first charge path with the first battery, wherein the first charge path allows charging the first battery when a power charger is coupled with the first charger receptacle; and
a first power-supply module that regulates power provided by the first battery to energize the first light source.

21. The electronics assembly of claim 20, wherein the first power-supply module is in electrical communication with the first battery and the first light source and is configured to regulate the current provided to the first light source to be within a predetermined range.

22. The electronics assembly of claim 20, wherein the power-supply module regulates a current applied to the first light source.

23. The electronics assembly of claim 20, wherein the power-supply module regulates a voltage applied to the first light source.

24. The electronics assembly of claim 20, wherein the power-supply module is a constant current driver coupled with the first light source and configured such that generally a constant current is applied to the first light source.

25. The electronics assembly of claim 20, further comprising:
a first control module that is configured to
receive a first voltage from the first battery,
in response to the first voltage that is above a first threshold, disallow charging the first battery,
in response to the first voltage that is not below a second threshold and not above the first threshold, allow charging the first battery, and
in response to the first voltage that is below the second threshold, disallow energizing the first light source by the first battery.

26. The electronics assembly of claim 25, wherein the first control module is further configured to:
disconnect the first charge path when disallowing charging the first battery, and
connect the first charge path when allowing charging the first battery.

27. The electronics assembly of claim 26, further comprising a first charge switch module located in the first charge path, wherein the first control module is further configured to output signals to the first charge switch module to selectively connect and disconnect the first charge path.

28. The electronics assembly of claim 27, wherein the first control module is further configured to disconnect the first discharge path when disallowing energizing the light source by the first battery.

29. The electronics assembly of claim 28, further comprising a first discharge switch module located in the first discharge path, wherein the first control module is further configured to output signals to selectively connect and disconnecting the first discharge path.

30. The electronics assembly of claim 20, further comprising a first switch that is in a communication path between the first light source and the first battery and that selectively allows and disallows energizing the first light source by the first battery.

31. The electronics assembly of claim 20, further comprising:
at least one second battery;
a second charger receptacle in electrical communication through a second charge path with the second battery, wherein the second charge path allows charging the second battery when a power charger is coupled with the second charger receptacle; and
a directional module located in an electrical communication path between the first and second charger receptacles and preventing current flow from the second charger receptacle to the first charger receptacle.

32. The electronics assembly of claim 20 configured to be used in a low-version reader that comprises an oculus lens, which has an induced prism in a range between about 4 PD and about 22 PD with a lens power that is greater than about +4.00 diopters and less than about +20.00 diopters such that in use, the oculus lens focuses at a distance that is greater than about 5 cm and less than about 25 cm.

33. The electronics assembly of claim 32, wherein the oculus lens is an oculus dexter lens or an oculus sinister lens.

34. An electrical circuitry, comprising:
an LED having an anode and a cathode;
a charger receptacle having an anode and a cathode;
at least one battery that is rechargeable, an anode of the battery being in electrical communication with the anode of the charger receptacle and the anode of the LED; and
a power-supply circuit that regulates power provided by the battery to energize the LED, the power-supply circuit having first, second, and third nodes, wherein
the first node is in electrical communication with the anode of the LED,
the second node is in electrical communication with the cathode of the LED,
the third node is in electrical communication with the cathode of the battery.

35. The electrical circuitry of claim 34, further comprising
a control circuit having at least nodes S, M, C, and D;
wherein the at least one battery includes first and second batteries connected via an intermediate node;
wherein the node S is in electrical communication with the anode of the first battery, the node M is in electrical communication with the intermediate node;
wherein the control circuit is configured to,
in response to a voltage that is applied to the node S and that is above a first threshold, output a signal at a first voltage at the node C and a signal at a second voltage at the node D,
in response to a voltage that is applied to the node S and that is below a second threshold, output a signal at the first voltage at the node D,
in response to a voltage that is applied to the node S and that is not below the second threshold and that is not above the first threshold, output a signal at the second voltage at the node C.

36. The electrical circuitry of claim 35, further comprising:
a switch circuit in the charge path and the discharge path and having charge input node, discharge input node, charge source node, and discharge source node, wherein
the charge input node is in electrical communication with the node C,
the charge source node is in electrical communication with the cathode of the charger receptacle,
the discharge input node is in electrical communication with the node D,
the discharge source node is in electrical communication with the cathode of the second battery, and
the switch circuit selectively connect and disconnect the charge and discharge paths in accordance with signals received at the charge and discharge input nodes, respectively.

37. The electrical circuitry of claim 35, wherein the control circuit further balances voltages of the first and second batteries in response to a voltage detected at the M node.

38. The electrical circuitry of claim 34, further comprising a reed switch placed in one of (a) an electrical communication path between the anode of the LED and the anode of the first battery and (b) an electrical communication path between a cathode of the LED and the cathode of the second battery.

39. The electrical circuitry of claim 34, further comprising a diode, an anode of the diode in electrical communication with the anode of the charger receptacle, a cathode of the diode in electrical communication with the anode of the first battery.

40. The electrical circuitry of claim 34 configured to be used in a low-version reader that comprises an oculus lens, which has an induced prism in a range between about 4 PD and about 22 PD with a lens power that is greater than about +4.00 diopters and less than about +20.00 diopters such that in use, the oculus lens focuses at a distance that is greater than about 5 cm and less than about 25 cm.

41. The electrical circuitry of claim 40, wherein the oculus lens is an oculus dexter lens or an oculus sinister lens.
